(19) United States
(12) Patent Application Publication
(10) Pub. No.: US 2009/0084270 A1
(43) Pub. Date: Apr. 2, 2009

(54) Electrically and battery powerd coffeemaker

(76) Inventor: Washington Pinheiro, Allston, MA (US)

Correspondence Address: Jim Montgomery, 8th Floor, 5201 Blue Lagoon Drive, Miami, FL, 33126, US

(21) Appl. No.: 11/986,176

(22) Filed: Nov. 19, 2007

Related U.S. Application Data
(60) Provisional application No. 60/976,475, filed on Oct. 1, 2007.

(51) Int. Cl. A47J 31/00

(52) U.S. Cl. 99/280

(57) ABSTRACT

An apparatus for making coffee is presented. The apparatus includes a housing having a water tank, a filter basket for containing coffee grounds and a filter where heated water passes through the grounds and filter to brew the coffee, a warming plate, a battery compartment for batteries and a switch for turning the apparatus on and off. A carafe contains the coffee where the carafe is placed on the warming plate to keep the coffee heated. An electrical cord passes into the housing where when the electrical cord is plugged into a electrical outlet and the power switch turns the apparatus on, the apparatus uses electrical power from the outlet to heat the water and warming plate. When the electrical cord is unplugged and the power switch turns the apparatus on, the apparatus uses electrical power from the batteries to heat the water and warming plate.

### CROSS-REFERENCE TO RELATED APPLICATIONS

The present Utility patent application claims priority benefit of the [U.S. provisional application for patent Ser. No. 60976475 filed on Oct. 1, 2007 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to household appliances. More particularly, the invention relates to a coffee making device that is both electrically and battery powered.

### BACKGROUND OF THE INVENTION

There may be instances where a person would like to brew coffee when electricity is not available, for example, without limitation, during a power outage or while camping. Current methods of making coffee without electricity include pouring boiling water onto coffee grounds, for example in a French press or boiling the coffee grounds in water, for example in a percolator or on a stovetop. These methods however do not always produce coffee to the drinker's liking. For example, without limitation, the filtering systems used in these methods are not as thorough as in automatic coffee makers and the grounds often end up in the coffee. Also, the user is responsible for determining how long to brew the coffee in these methods and typically must rely only on the color of the coffee to do so. This often results in coffee that is too strong or too weak.

In view of the foregoing, there is a need for improved techniques for automatically making coffee with or without electricity.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a side perspective view of an exemplary electrically and battery operated coffeemaker, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, electrically and battery powered coffeemaker is presented.

In one embodiment, an apparatus for making coffee is presented. The apparatus includes a housing including a water tank for receiving water to brew coffee, a filter basket for containing coffee grounds and a filter where heated water exiting from the water tank passes through the grounds and filter to brew the coffee, a warming plate, a battery compartment for batteries that are suitable for powering the apparatus to heat the water and warming plate and a switch for turning the apparatus on and off. A carafe contains the coffee exiting the filter basket where the carafe is placed on the warming plate to keep the coffee heated. An electrical cord passes into the housing where when the electrical cord is plugged into a suitable electrical outlet and the power switch turns the apparatus on, the apparatus uses electrical power from the electrical outlet to heat the water and warming plate to brew the coffee and keep the coffee heated. When the electrical cord is unplugged and the power switch turns the apparatus on, the apparatus uses electrical power from the batteries to heat the water and warming plate to brew the coffee and keep the coffee heated. In another embodiment, when the electrical cord is plugged into the electrical outlet where power from the electrical outlet is unavailable and the power switch turns the apparatus on, the apparatus uses electrical power from the batteries to heat the water and warming plate to brew the coffee and keep the coffee heated. In other embodiments the housing is fabricated from plastic material and is lightweight and portable the housing further including a water cover for covering the water tank and the housing further including a water window for viewing a level of water in the water tank. In a further embodiment, the batteries are of an alkaline or lithium type.

In another embodiment an apparatus for making coffee is presented. The apparatus includes means for receiving water, coffee grounds, and a filter such that heated water passes through the coffee grounds and filter to brew coffee, means for receiving the coffee, means for warming a plate to keep the coffee heated, means for storing batteries for powering the apparatus, means for providing power from an electrical outlet and means for turning the apparatus on and off where when the apparatus is on and power is available from the electrical outlet, the apparatus uses power from the electrical outlet to brew the coffee and warm the plate and when power is unavailable from the electrical outlet the apparatus uses power from the batteries to brew the coffee and warm the plate.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Embodiments of the present invention provide coffee drinkers with an easy method of making coffee with or without electricity. The preferred embodiment is a kitchen appliance that makes coffee using electricity or batteries.

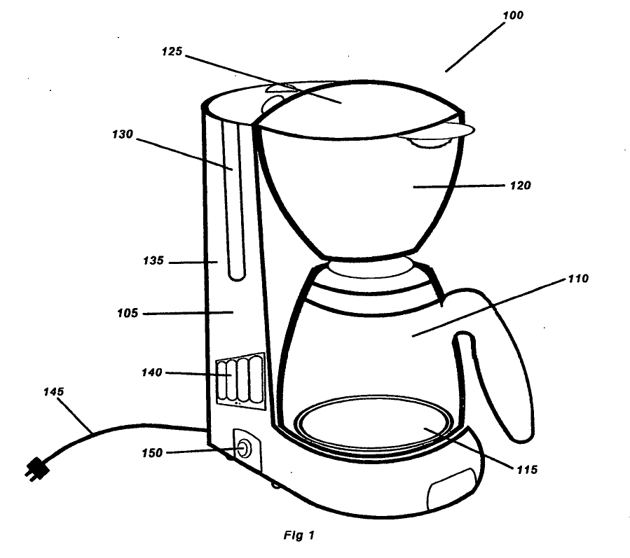

FIG. 1 is a side perspective view of an exemplary electrically and battery operated coffeemaker 100, in accordance with an embodiment of the present invention. In the present embodiment, coffeemaker 100 is an automatic drip-brew machine comprising an exterior body 105 made of plastic, a carafe 110 made of glass, and a warming plate 115 and internal heating elements made of metal. In alternate embodiments, these components may be made of various different materials. The present embodiment also comprises a filter basket 120, a water tank 135, a water cover 125, and a water window 130. Filter basket 120 houses the filtering system of coffeemaker 100, where the hot water is passed through the coffee grounds and the coffee is brewed. Water cover 125 covers water tank 135 on the back of coffeemaker 110 into which a user pours water for making the coffee. Water window 130 enables a user to see how much water is in water tank 135.

Coffeemaker 100 can be operated with both battery power and electricity. In the present embodiment the batteries may be inserted into coffeemaker 100 in a battery compartment 140. In alternate embodiments the battery compartment may be located in different locations for example, without limitation, the underside or the back of the coffeemaker. It is beneficial to place the batteries near the heating elements since the heating elements use the battery power when the coffeemaker is not plugged in electrically. Those skilled in the art, in light of the present teachings, will recognize that different types of batteries may be used to power coffeemaker 100 such as, but not limited to, alkaline batteries of various sizes, lithium batteries of various sizes, etc. Coffeemaker 100 may be operated electrically by plugging in a conventional electrical cord 145 into a wall outlet. The user can turn coffeemaker 100 on or off using a power switch 150. Some embodiments may also include a timer feature, enabling the user to set the timer to turn on the coffeemaker automatically.

In typical use of the present embodiment, a user measures an appropriate amount of coffee grounds into filter basket 120 and inserts filter basket 120 into coffeemaker 100. The user also pours an appropriate amount of water into water tank 135 and closes water cover 125. The user then turns on coffeemaker 100 using power switch 150, and coffeemaker 100 automatically brews the coffee, even if electrical cord 145 is unplugged or if there is a power outage.

In the present embodiment, coffeemaker 100 is lightweight and portable, weighing approximately three pounds. However, alternate embodiments may be larger and less portable. Furthermore, coffeemaker 100 can be made in various colors to accentuate living decor. Those skilled in the art, in light of the present teachings, will recognize that numerous types and styles of coffeemakers may be used in embodiments of the present invention such as, but not limited to, conventional coffeemakers, single cup coffee makers, coffee makers with various different types of carafes, etc.

Having fully described at least one embodiment of the present invention, other equivalent or alternative methods of providing a coffeemaker that may be powered by batteries or electricity according to the present invention will be apparent to those skilled in the art. The invention has been described above by way of illustration, and the specific embodiments disclosed are not intended to limit the invention to the particular forms disclosed. For example, the particular implementation of the coffeemaker may vary depending upon the particular type of batteries used. The coffeemakers described in the foregoing were directed to household implementations; however, similar techniques are to power the coffeemaker with larger or more batteries for larger capacity coffeemakers, such as, but not limited to, those used in restaurants or coffee shops. Large capacity implementations of the present invention are contemplated as within the scope of the present invention. The invention is thus to cover all modifications, equivalents, and alternatives falling within the spirit and scope of the following claims.

What is claimed is:

1. An apparatus for making coffee, the apparatus comprising:
a housing comprising:
a water tank for receiving water to brew coffee;
a filter basket for containing coffee grounds and a filter where heated water exiting from said water tank passes through said grounds and filter to brew the coffee;
a warming plate;
a battery compartment for batteries that are suitable for powering the apparatus to heat said water and warming plate; and
a switch for turning the apparatus on and off; and
a carafe for containing the coffee exiting said filter basket where said carafe is placed on said warming plate to keep the coffee heated; and
an electrical cord passing into said housing where when said electrical cord is plugged into a suitable electrical outlet and said power switch turns the apparatus on, the apparatus uses electrical power from said electrical outlet to heat said water and warming plate to brew the coffee and keep the coffee heated and when said electrical cord is unplugged and said power switch turns the apparatus on, the apparatus uses electrical power from said batteries to heat said water and warming plate to brew the coffee and keep the coffee heated.

2. The apparatus as recited in claim 1, wherein when said electrical cord is plugged into said electrical outlet where power from said electrical outlet is unavailable and said power switch turns the apparatus on, the apparatus uses electrical power from said batteries to heat said water and warming plate to brew the coffee and keep the coffee heated.

3. The apparatus as recited in claim 2, wherein said housing is fabricated from plastic material and is lightweight and portable.

4. The apparatus as recited in claim 2, wherein said housing further comprising a water cover for covering the water tank.

5. The apparatus as recited in claim 2, wherein said housing further comprising a water window for viewing a level of water in said water tank.

6. The apparatus as recited in claim 2, wherein said batteries are of an alkaline or lithium type.

7. An apparatus for making coffee, the apparatus comprising:
means for receiving water, coffee grounds, and a filter such that heated water passes through said coffee grounds and filter to brew coffee;
means for receiving the coffee;
means for warming a plate to keep the coffee heated;
means for storing batteries for powering the apparatus;
means for providing power from an electrical outlet; and
means for turning the apparatus on and off where when the apparatus is on and power is available from said electrical outlet, the apparatus uses power from said electrical outlet to brew the coffee and warm said plate and when power is unavailable from said electrical outlet the apparatus uses power from said batteries to brew the coffee and warm said plate.
